(19) United States
(12) Patent Application Publication
(10) Pub. No.: US 2023/0231882 A1
(43) Pub. Date: Jul. 20, 2023

(54) HONEYPOT IDENTIFICATION METHOD, APPARATUS, DEVICE, AND MEDIUM BASED ON CYBERSPACE MAPPING

(71) Applicant: Tencent Cloud Computing (Beijing) Co., Ltd., Beijing (CN)

(72) Inventor: Shufan DENG, Shenzhen (CN)

(73) Assignee: Tencent Cloud Computing (Beijing) Co., Ltd., Beijing (CN)

(21) Appl. No.: 18/188,850

(22) Filed: Mar. 23, 2023

Related U.S. Application Data
(63) Continuation of application No. PCT/CN2021/106603, filed on Jul. 15, 2021.

(30) Foreign Application Priority Data
Jun. 10, 2021 (CN) 202110650833.2

(51) Int. Cl. H04L 9/40

(52) U.S. Cl. CPC H04L 63/1491

(57) ABSTRACT

A honeypot identification method based on cyberspace mapping provides improved accuracy and efficiency of identifying a honeypot. One or more open ports corresponding to a target Internet Protocol address and a target open port for login are determined. Account login information of the target open port is acquired. A service of the target open port is logged into to acquire system environment information. Cyberspace mapping data is determined based on the one or more open ports, port fingerprint information of the one or more open ports, and the system environment information. A honeypot identification result of the target Internet Protocol address is obtained based on the cyberspace mapping data.

### RELATED APPLICATION

This application claims priority as a continuation of PCT/CN2021/106603, filed on Jul. 15, 2021, published as WO2022257226A1, and entitled “CYBERSPACE MAPPING-BASED HONEYPOT RECOGNITION METHOD AND APPARATUS, DEVICE, AND MEDIUM,” which claims priority to Chinese Patent Application No. 202110650833.2, filed on Jun. 10, 2021 and entitled “HONEYPOT IDENTIFICATION METHOD, APPARATUS, DEVICE, AND MEDIUM BASED ON CYBERSPACE MAPPING,” each of which are hereby incorporated herein by reference in their entirety.

### FIELD OF THE TECHNOLOGY

This disclosure relates to the field of Internet technologies, and in particular, to a honeypot identification method, apparatus, device, and medium based on cyberspace mapping.

### BACKGROUND OF THE DISCLOSURE

During a network security evaluation process, vulnerabilities are found in some Internet Protocol (IP) addresses. However, systems in which these IP addresses are located may not be real service systems, but honeypots deployed artificially. In order to enhance effectiveness of network security evaluation, identifying whether an IP address is a honeypot is generated.

### SUMMARY

Some embodiments provide a honeypot identification method, apparatus, device, and medium based on cyberspace mapping, which can improve identification efficiency of a honeypot and improve identification accuracy of the honeypot.

Some embodiments provide a honeypot identification method based on cyberspace mapping, including:
determining one or more open ports corresponding to a target Internet Protocol address;
determining a target open port from the one or more open ports, and acquiring account login information corresponding to the target open port, a service type corresponding to the target open port being an account login service type;
logging in to a service of the target open port according to the account login information, and determining system environment information corresponding to the target open port;
determining cyberspace mapping data corresponding to the target Internet Protocol address based on the one or more open ports, the account login information, and the system environment information; and
performing data analysis on the cyberspace mapping data to determine a first honeypot identification result corresponding to the target Internet Protocol address.

Some embodiments provide a honeypot identification apparatus based on cyberspace mapping, including:
a port open detection module, configured to determine one or more open ports corresponding to a target Internet Protocol address;
a fingerprint detection module, configured to: determine a target open port from the one or more open ports, and acquire account login information corresponding to the target open port, a service type corresponding to the target open port being an account login service type;
an account login module, configured to log in to a service of the target open port according to the account login information, and determine system environment information corresponding to the target open port;
a data summarizing module, configured to determine cyberspace mapping data corresponding to the target Internet Protocol address based on the one or more open ports, the account login information, and the system environment information; and
a first data analysis module, configured to perform data analysis on the cyberspace mapping data to determine a first honeypot identification result corresponding to the target Internet Protocol address.

Some embodiments provide a computer device, including a memory and a processor, where the memory is connected to the processor, the memory is configured to store a computer program, and the processor is configured to invoke the computer program, so that the computer device performs the method provided in the foregoing embodiments.

Some embodiments provide a non-transitory computer readable storage medium. The non-transitory computer readable storage medium stores a computer program. The computer program is suitable for being loaded and executed by a processor, so that a computer device having the processor performs the method provided in the foregoing embodiments.

Some embodiments provide a computer program product or a computer program, the computer program product or the computer program including computer instructions, the computer instructions being stored in a non-transitory computer readable storage medium. A processor of a computer device reads the computer instructions from the non-transitory computer readable storage medium, and the processor executes the computer instructions, so that the computer device performs the methods described.

When honeypot identification is performed on a target IP address, cyberspace mapping is used for analyzing the target IP address, and cyberspace mapping data in a cyberspace mapping process is summarized for comprehensive analysis to determine a honeypot identification result of the target IP address, thereby improving identification accuracy of the honeypot.

### BRIEF DESCRIPTION OF THE DRAWINGS

FIG. 1 is a schematic structural diagram of an example network architecture according to some embodiments of this disclosure.

FIG. 2a and FIG. 2b are schematic diagrams of an example honeypot identification scenario according to some embodiments of this disclosure.

FIG. 3 is a schematic flowchart of an example honeypot identification method based on cyberspace mapping according to some embodiments of this disclosure.

FIG. 4 is a diagram of an example honeypot identification according to some embodiments of this disclosure.

FIG. 5 is a schematic flowchart of an example honeypot identification method based on cyberspace mapping according to some embodiments of this disclosure.

FIG. 6 is a schematic diagram of an example data storage according to some embodiments of this disclosure.

FIG. 7 is a schematic diagram of an example behavior log storage according to some embodiments of this disclosure.

FIG. 8 is an architectural diagram of an example honeypot identification technology according to some embodiments of this disclosure.

FIG. 9 is a schematic structural diagram of an example honeypot identification apparatus based on cyberspace mapping according to some embodiments of this disclosure.

FIG. 10 is a schematic structural diagram of an example computer device of some embodiments of this disclosure.

### DESCRIPTION OF EMBODIMENTS

The solutions of this disclosure are described below with reference to the accompanying drawings in the embodiments of this disclosure. The accompanying drawings and the following description show and describe some embodiments of this disclosure, and additional embodiments may be understood within the scope of this disclosure.

This disclosure relates to the following concepts:

Honeypot: A honeypot technology is a technology of attracting and counteracting an attacker. With arrangement of some hosts, network services, or information as bait, an attacker is tempted to attack them, so as to help capture and analyze an attack behavior, understand a tool and a method used by the attacker, speculate an attack intention and a motivation, so that a defender can clearly understand a security threat faced, and strengthen a security protection capability of an actual system by using technology and management methods.

Cyberspace mapping: Cyberspace mapping is cyberspace-oriented, is based on computer science, network science, mapping science, and information science, and may use network exploration, network analysis, entity locating, geographical mapping and geographic information system. Through detection, collection, processing, analysis and presentation, the location, attribute and topology structure of cyberspace entity resources and virtual resources in cyberspace may be obtained, and space analysis and application are implemented accordingly.

Internet Protocol address (IP address): The IP address is a uniform address format provided by the IP protocol, and a physical address difference is shielded by allocating a logical address to each network and each host on the Internet.

In some honeypot identification technology, a to-be-identified IP address is manually detected. Because a detection process of the IP address is a complex task, a complex operation is often performed, and a detection effect of the to-be-identified IP address depends on a capability of an operator. When the capability of the operator is limited, it is easy to misjudge an identification result of the honeypot. However, some embodiments provide a honeypot identification method, which can perform honeypot identification by using cyberspace mapping, thereby improving honeypot identification efficiency.

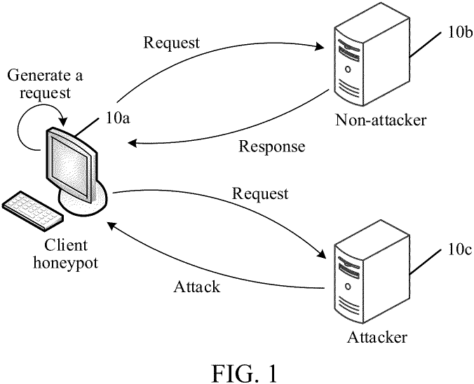

Referring to FIG. 1, FIG. 1 is a schematic structural diagram of a network system. The network system shown in FIG. 1 is a honeypot network system. As the information age arrives, computer network security protection is converted from passive defense to active defense, so that the honeypot technology is increasingly valued in network confrontation. A honeypot is an effective means to understand an attacker deeply, and can improve a network security protection level. The network system shown in FIG. 1 includes a terminal device 10a, a server 10b, a server 10c, and the like. The network system includes one or more servers. Any quantity of servers in the network system may be used. The terminal device 10a is closely monitored as a client honeypot. The terminal device 10a includes a false high-value resource and some vulnerabilities, so as to attract an attacker to invade the client honeypot. In a process in which the terminal device 10a is invaded, attack traffic, behavior, and data of the attacker are recorded and audited in real time, so as to understand a manner, a method, and an objective of the attacker, and complete subsequent work such as tracing and obtaining evidence. The server 10b is a server that works normally (that is, a non-attacker). The terminal device 10a transmits a generated request to the server 10b. After receiving the request, the server 10b that works normally responds to the terminal device 10a. Alternatively, the server 10c is a malicious server (that is, an attacker). The terminal device 10a transmits a generated request to the server 10c. After receiving the request, the server 10c does not make a normal response to the terminal device 10a, but initiates an attack to the terminal device 10a, so as to invade the terminal device 10a. When the server 10c (attacker) invades the terminal device 10a (client honeypot), an attack behavior of the server 10c can be captured and analyzed in real time.

The terminal device 10a shown in FIG. 1 includes a device such as a smartphone, a tablet computer, a notebook computer, a palmtop computer, a mobile Internet device (MID), a wearable device (such as a smart watch and a smart band), a smart TV, a desktop computer, and a network host. The server 10b and the server 10c each are an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

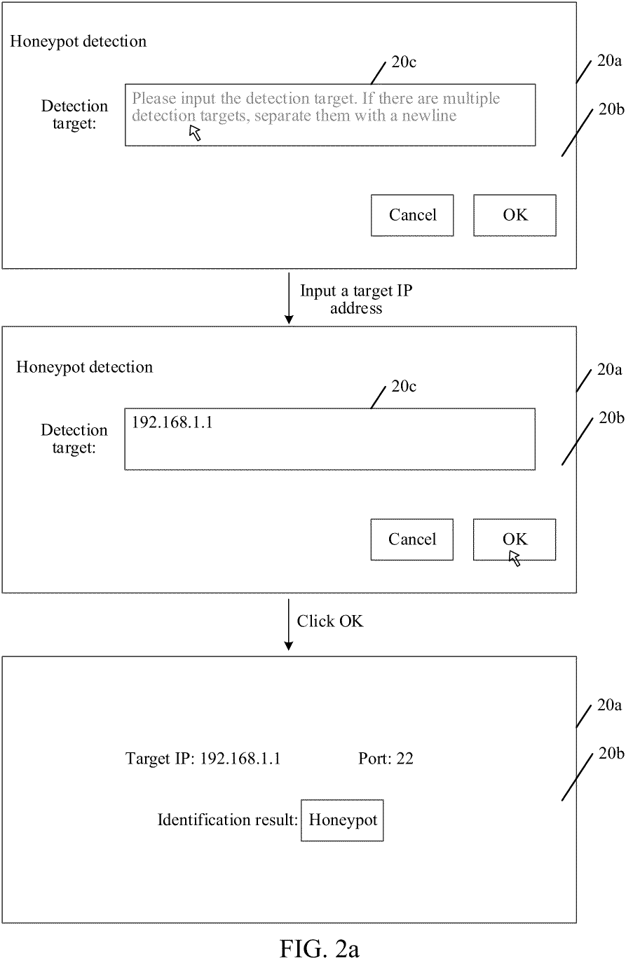

Referring to FIG. 2a and FIG. 2b, FIG. 2a and FIG. 2b are schematic diagrams of an example honeypot identification scenario. A terminal device 20a shown in FIG. 2a is a device used by a user, and the terminal device 20a is integrated with a honeypot identification function. A current display interface shown in FIG. 2a is a honeypot detection page 20b. An address input area 20c, a “cancel” control, and an “OK” control are displayed on the honeypot detection page 20b, where the address input area 20c is used for inputting one or more to-be-identified IP addresses, and when multiple IP addresses are inputted in the address input area 20c, a line break is inputted in the address input area 20c. When the user performs a trigger operation on the address input area 20c in the honeypot detection page 20b, and inputs a target IP address (192.168.1.1) in the address input area 20c, the terminal device 20a responds to the trigger operation for the address input area 20c, and displays, in the address input area 20c, the target IP address inputted by the user: 192.168.1.1.

After the user completes the input operation of the target IP address, a trigger operation (for example, a click operation) is performed on the “OK” control in the honeypot detection page 20b. The terminal device 20a acquires, in response to the trigger operation for the “OK” control, the target IP address inputted in the address input area 20c: 192.168.1.1, and performs honeypot identification on the target IP address (192.168.1.1) by cyberspace mapping, to obtain a honeypot identification result corresponding to the target IP address (192.168.1.1) as follows: a honeypot. The honeypot identification result and a corresponding port (the port number is 22) are displayed on the honeypot detection page 20b, that is, the target IP address (192.168.1.1) is obtained through detection by the terminal device 20a as a honeypot. In the entire honeypot identification process for the target IP address (192.168.1.1), the user can automatically obtain the honeypot identification result by simply inputting the target IP address (192.168.1.1) on a honeypot detection page, which can reduce a cumbersome operation of the user, and further improve honeypot identification efficiency for the target IP address.

In some embodiments, the honeypot identification process of the target IP address (192.168.1.1) by the terminal device 20a includes: As shown in FIG. 2b, after obtaining the target IP address (192.168.1.1), the terminal device 20a analyzes the target IP address (192.168.1.1) to obtain address key information corresponding to the target IP address (192.168.1.1), where the address key information includes geographic area location information (for example, information such as a continent, a country, a province, a city, and a district/county) of the target IP address (192.168.1.1), holder information (for example, information such as an operator and an owner), and a security label. In addition, the terminal device 20a acquires a port set 20d corresponding to the target IP address (192.168.1.1). Because the port number of the IP address is represented by two bytes (a binary number of 16 bits), the port set 20d includes 65536 port numbers, and a value range thereof is 0 to 65535, that is, the target IP address (192.168.1.1) is corresponding to 65536 ports. The IP address may be connected to a target computer. To access a service (or an application program) in the target computer, a port number is specified, and different services are distinguished by using the port number. The IP address is used for uniquely identifying a computer. One IP address corresponds to 65536 port numbers. Port numbers between 0 and 1023 are used for some common network services and applications. A common application of a user uses a port number greater than 1024, so that the port number can be prevented from being occupied by another application or service.

Further, the terminal device 20a sequentially performs port open detection on the 0-65535 ports included in the port set 20d to obtain open statuses respectively corresponding to the 65536 ports. For example, an open status of the port 0 is an opened state, an open status of the port 1 is an opened state, an open status of the port 2 is an opened state, an open status of the port 3 is an opened state, ..., and an open status of the port 65535 is a not opened state. The terminal device 20a determines a port in an opened state as an open port, so as to obtain an open port list 20e corresponding to the target IP address (192.168.1.1). For example, the open port list 20e includes an open port 3, an open port 22, ..., and an open port 808. Further, fingerprint detection analysis is performed on the target IP address (192.168.1.1) and the open port in the open port list 20e, to obtain port fingerprint information corresponding to each open port in the open port list 20e. For example, the port fingerprint information corresponding to the port 3 includes: the target IP address (192.168.1.1), the port 3, and a service type 1 (that is, a service type corresponding to a service of the port 3); the port fingerprint information corresponding to the port 22 includes: the target IP address (192.168.1.1), the port 22, and a service type 2; and the port fingerprint information corresponding to the port 808 includes: the target IP address (192.168.1.1), the port 808, and a service type 3.

Further, in response to that the service type 2 in the port fingerprint information corresponding to the open port 22 belongs to an account login service type (a service for login with an account and a password), a service of the port 22 is continuously attempted for login by using a large quantity of account and password combinations until an account and a password for successful login of the service of the port 22 are obtained, and the service of the port 22 is logged in by using the loggable account and password, so as to obtain system environment information of the port 22. In some embodiments, in response to that the service type 3 in the port fingerprint information corresponding to the open port 808 belongs to an account login service type, a login attempt may be used on a service of the port 808 by using a large quantity of account and password combinations. If an account and a password for successful login of the service of the port 808 cannot be finally obtained, system environment information of the logged-in port 808 cannot be acquired. In response to that the service type 1 in the port fingerprint information corresponding to the open port 3 is a non-account login service type (a service that does not require an account and a password for login), a login attempt of an account and password combination may not be required.

The terminal device 20a summarizes the address key information, the open port list 20e, and the port fingerprint information, the loggable account and password, and the system environment information that are respectively corresponding to each open port in the open port list 20e, to obtain cyberspace mapping data corresponding to the target IP address (192.168.1.1), and obtains, by performing data analysis on the cyberspace mapping data, a honeypot identification result corresponding to the target IP address (192.168.1.1) as follows: a honeypot result, and displays the honeypot result on the honeypot detection page 20b.

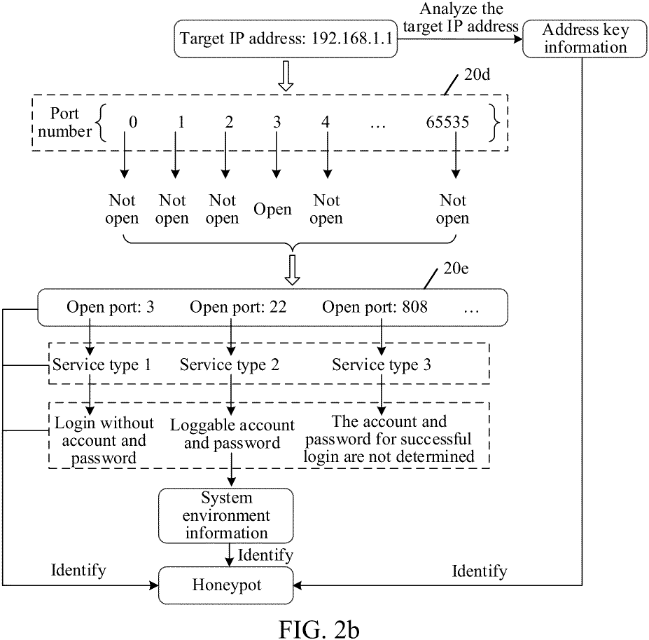

Referring to FIG. 3, FIG. 3 is a schematic flowchart of a honeypot identification method based on cyberspace mapping in some embodiments. The honeypot identification method based on cyberspace mapping may be performed by a computer device. The computer device is a terminal device, a server, a system including a terminal device and a server, or a computer program product or a computer program (including program code). As shown in FIG. 3, the honeypot identification method based on cyberspace mapping includes the following steps:

Step S101: Acquire a target Internet Protocol address from a honeypot detection page, perform port open detection on a port set corresponding to the target Internet Protocol address, and determine, in the port set, one or more open ports corresponding to the target Internet Protocol address.

In a network security assessment process, if a user wants to detect whether a target IP address is a honeypot, the user enters, in a honeypot detection page (for example, the honeypot detection page 20b in the embodiment corresponding to FIG. 2a) of a computer device (for example, the terminal device 20a in the embodiment corresponding to FIG. 2a), a target IP address (target Internet Protocol address) that is to be detected, where the honeypot detection page is a page that is provided by a client and that is used for detecting a honeypot, or is a web page that is used for detecting a honeypot and that is in a browser. In some embodiments, the honeypot detection page includes an address input area, and the address input area is used for displaying the target IP address inputted by the user. There are one or more target IP addresses inputted by the user in the address input area. When the user enters multiple target IP addresses in the address input area, the multiple target IP addresses are separated and displayed in a newline manner in the address input area. Alternatively, the multiple target IP addresses are separated and displayed in a semicolon form in the address input area.

The user completes an input operation of the target IP address in the address input area, and performs a trigger operation on an “OK” control in the honeypot detection page. The computer device obtains, in the address input area of the honeypot detection page, the target IP address inputted by the user, and further obtains a port set corresponding to the target IP address (for example, the port set 20d in the embodiment corresponding to FIG. 2b). The port set includes 65536 ports, and a value range of the port number is 0-65535. The computer device sequentially performs open port detection on the 65536 ports included in the port set to obtain an open status corresponding to each port, determines a port whose open status is an opened state as an open port, and further obtains, from the port set, one or more open ports (for example, the open port included in the open port list 20e in the embodiment corresponding to FIG. 2b) corresponding to the target IP address.

Each port has a corresponding port number, and different ports can be distinguished according to port numbers. The port set includes port numbers of multiple ports. The computer device performs open port detection on a port indicated by each port number included in the port set to obtain an open status corresponding to each port number, so as to determine a port number whose open status is an opened state, so as to indicate that a port corresponding to the port number is an open port.

In some other embodiments, the computer device may further acquire, in another manner, a target IP address that is to be detected, for example, receive a detection request transmitted by another device, where the detection request carries the target IP address that is to be detected. In addition, after the target IP address is obtained, one or more open ports corresponding to the target IP address can be acquired in another manner.

Step S102: Perform fingerprint detection analysis on the target Internet Protocol address and the one or more open ports and acquire port fingerprint information corresponding to the one or more open ports.

In some embodiments, after the one or more open ports corresponding to the target IP address are obtained, the computer device performs fingerprint detection analysis on the target IP address and the one or more open ports to acquire the port fingerprint information corresponding to the one or more open ports, where a data structure field of the port fingerprint information includes the target IP address, the open port, and a service type corresponding to the open port. In some embodiments, the computer device transmits data (for example, a “\ r\ n\ r\ n” character) to the target IP address on the network by using one or more ports. A target server corresponding to the target IP address returns response data (for example, a “a001” field) for the data. The computer device performs feature analysis on the corresponding response data to obtain a service type respectively corresponding to the one or more ports.

In some embodiments, a port number is used for indicating a corresponding port, and the port fingerprint information includes the target IP address, a port number corresponding to an open port, and a service type corresponding to the open port.

In some other embodiments, the computer device may further acquire, in another manner, the port fingerprint information corresponding to the one or more open ports, for example, perform fingerprint detection analysis on each port in advance, acquire the port fingerprint information corresponding to each port, and store the port fingerprint information. Then, in response to obtaining the one or more open ports corresponding to the target IP address, the port fingerprint information corresponding to the one or more open ports is determined by querying stored port fingerprint information.

Step S103: Determine, according to a service type in the port fingerprint information, an open port whose service type is an account login service type as a target open port, to acquire account login information corresponding to the target open port.

In some embodiments, in the one or more open ports, different open ports are used for distinguishing between different services, that is, different open ports are corresponding to different service types, and the service types include an account login service type and a non-account login service type. The computer device determines an open port whose service type is the account login service type as the target open port, and further performs continuous login attempts on a service of the target open port by using a large quantity of account and password combinations (a login attempt process using a large quantity of accounts and passwords is referred to as a brute-force attack process), and determines an account and password combination for successful login as the account login information corresponding to the target open port, where each account and password combination includes an account and a password.

In some embodiments, a port number is use for indicating a corresponding port. The computer device acquires the port number corresponding to the open port and the service type corresponding to the open port, and determines a port number of an open port whose service type is the account login service type, to indicate that the port corresponding to the port number is the target open port.

For example, the one or more open ports corresponding to the target IP address include: a port 2, a port 6, and a port 20. A service type in port fingerprint information corresponding to the port 2 is the account login service type, a service type in port fingerprint information corresponding to the port 6 is the non-account login service type, and a service type in port fingerprint information corresponding to the port 20 is the account login service type. The computer device determines the port 2 and the port 20 as the target open ports, and after continuously attempting to log in to the service of the port 2 by using a large quantity of accounts and passwords, determines an account and a password for successful login, and determines the account and the password for successfully logging in to the port 2 as account login information corresponding to the port 2. Similarly, the computer device further acquires account login information corresponding to the port 20.

Steps S101 to S103 provide a manner of determining the target open port. In some other embodiments, the target open port whose service type is the account login service type can be determined from the one or more open ports in another manner.

Step S104: Log in to a service of the target open port according to the account login information, acquire, by using the logged-in target open port, an instruction execution result indicated by a target operation instruction, and determine the system environment information corresponding to the target open port according to the instruction execution result.

In some embodiments, after obtaining the account login information corresponding to the target open port, the computer device logs in to the service of the target open port by using an account and a password in the account login information, and transmits a target operation instruction to the target server according to the target IP address and the target open port, so that the target server executes the target operation instruction, acquires an instruction execution result returned by the target server for the target operation instruction, and further determines the system environment information based on the target Internet Protocol address, the target open port, the target operation instruction, and the instruction execution result. In other words, after receiving the target operation instruction transmitted by the computer device, the target server executes the target operation instruction in the target server to obtain an instruction execution result corresponding to the target operation instruction, and returns the instruction execution result to the computer device to acquire the system environment information corresponding to the target open port.

In some embodiments, the target IP address, the target open port, the service type corresponding to the target open port, the account login information, the target operation instruction, and the instruction execution result are determined as the system environment information.

For example, if a port number is used for indicating a corresponding port, a target IP address, a port number corresponding to a target open port, a service type corresponding to the target open port, account login information, a target operation instruction, and an instruction execution result are determined as system environment information.

In some other embodiments, after the service of the target open port is logged in according to the account login information, the system environment information corresponding to the target open port can be further determined in another manner.

Step S105: Combine address key information corresponding to the target Internet Protocol address, the one or more open ports, port fingerprint information corresponding to the one or more open ports, the account login information, and the system environment information into cyberspace mapping data corresponding to the target Internet Protocol address.

In some embodiments, after obtaining the target IP address, the computer device analyzes the target IP address to obtain address key information, where the address key information may refer to basic information of the target IP address, such as geographic area location information, holder information, and a security label. The computer device combines the address key information, the one or more open ports, the port fingerprint information corresponding to the one or more open ports, the account login information, and the system environment information into the cyberspace mapping data corresponding to the target IP address.

In some embodiments, a port number is used for indicating a corresponding port. The computer device combines the address key information, port numbers of the one or more open ports, the port fingerprint information corresponding to the one or more open ports, the account login information, and the system environment information into the cyberspace mapping data corresponding to the target IP address.

In some other embodiments, the computer device may further determine the cyberspace mapping data in another manner, and may ensure that the cyberspace mapping data corresponding to the target Internet Protocol address is determined based on the one or more open ports, the account login information, and the system environment information.

Step S106: Separately perform data analysis on the cyberspace mapping data by using K honeypot identification policies included in an identification policy set, to obtain analysis results respectively corresponding to the K honeypot identification policies, and determine a first honeypot identification result corresponding to the target Internet Protocol address according to the K analysis results, the K honeypot identification policies being used for identifying different types of honeypots, and K being a positive integer.

In some embodiments, after obtaining the cyberspace mapping data, the computer device acquires the K honeypot identification policies included in the identification policy set, where the K honeypot identification policies are used for identifying different types of honeypots, K is a positive integer, for example, values of K are 1, 2, ...; further, performs data analysis successively on the cyberspace mapping data by using the K honeypot identification policies, to obtain the analysis results respectively corresponding to the K honeypot identification policies, determines, according to the analysis results respectively corresponding to the K honeypot identification policies, the first honeypot identification result corresponding to the target IP address, and displays the first honeypot identification results on the honeypot detection page. The first honeypot identification result includes a honeypot result and an undetermined result. In response to that a honeypot result exists in the analysis results corresponding to the K honeypot identification policies, the first honeypot identification result of the target IP address is determined as the honeypot result, and in response to that no honeypot result exists in the analysis results corresponding to the K honeypot identification policies, that is, the analysis results corresponding to the K honeypot identification policies are all undetermined results and it is unable to determine whether the target IP address is a honeypot. Therefore, the first honeypot identification result in this case is an undetermined result. In some embodiments, an analysis result corresponding to each honeypot identification policy is a probability that the target IP address is a honeypot. A weighted sum is performed on probabilities in the K analysis results to determine the first honeypot identification result corresponding to the target IP address, that is, a final first honeypot identification result uses the analysis results respectively corresponding to the K honeypot identification policies as consideration factors.

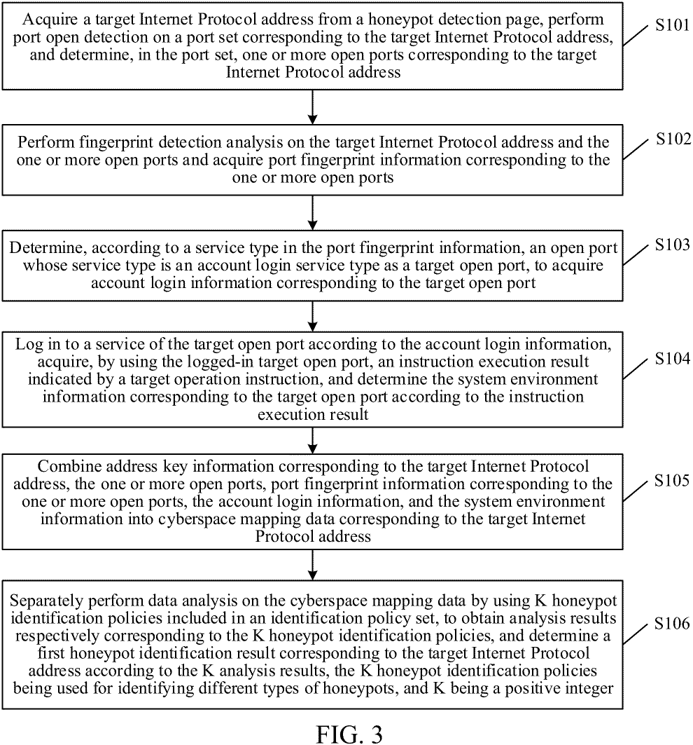

In some embodiments, when there are multiple target IP addresses, honeypot identification is performed on the multiple target IP addresses to obtain first honeypot identification results respectively corresponding to the multiple target IP addresses, and the first honeypot identification results respectively corresponding to the multiple target IP addresses are displayed on the honeypot detection page. Referring to FIG. 4, FIG. 4 is a diagram of a honeypot identification interface in some embodiments. The terminal device 30a shown in FIG. 4 is a device (that is, a computer device) used by the user, and the terminal device 30a is integrated with a honeypot identification function. A current display interface shown in FIG. 4 is a honeypot detection page 30b. An address input area 30c, a “cancel” control, and an “OK” control are displayed on the honeypot detection page 30b. When the user performs a trigger operation on the address input area 30c in the honeypot detection page 30b, and inputs target IP addresses (192.168.1.1 and 192.168.1.3) in the address input area 30c, the terminal device 30a responds to the trigger operation for the address input area 30c, and displays, in the address input area 30c, the target IP addresses inputted by the user. 192.168.1.1 and 192.168.1.3.

After the user completes the input operation of the target IP addresses, a trigger operation (for example, a click operation) is performed on the “OK” control in the honeypot detection page 30b. The terminal device 30a responds to the trigger operation for the “OK” control to acquire the target IP addresses: 192.168.1.1 and 192.168.1.3 that are inputted in the address input area 30c, and separately performs honeypot identification on the target IP address (192.168.1.1) and the target IP address (192.168.1.3) by using cyberspace mapping, to obtain a first honeypot identification result corresponding to the target IP address (192.168.1.1): a honeypot result, and a first honeypot identification result corresponding to the target IP address (192.168.1.3): also a honeypot result. The honeypot detection page 30b simultaneously displays the first honeypot identification result (the honeypot result) corresponding to the target IP address (192.168.1.1) and a corresponding port (a port number is 22), and the first honeypot identification result (the honeypot result) corresponding to the target IP address (192.168.1.3) and a corresponding port (a port number is 25). In other words, the target IP address (192.168.1.1) and the target IP address (192.168.1.3) are both honeypots through detection by the terminal device 30a.

In some other embodiments, the cyberspace mapping data can be analyzed in another manner to obtain the first honeypot identification result corresponding to the target IP address.

In some embodiments, when honeypot identification is performed on a target IP address, the target IP address is analyzed by using cyberspace mapping, and cyberspace mapping data is summarized for comprehensive analysis, so as to determine a honeypot identification result of the target IP address, thereby improving honeypot identification accuracy. In addition, a user may input the target IP address in a honeypot detection page to obtain a honeypot identification result of the target IP address, which can reduce a cumbersome operation of the user, and further improve honeypot identification efficiency for the target IP address.

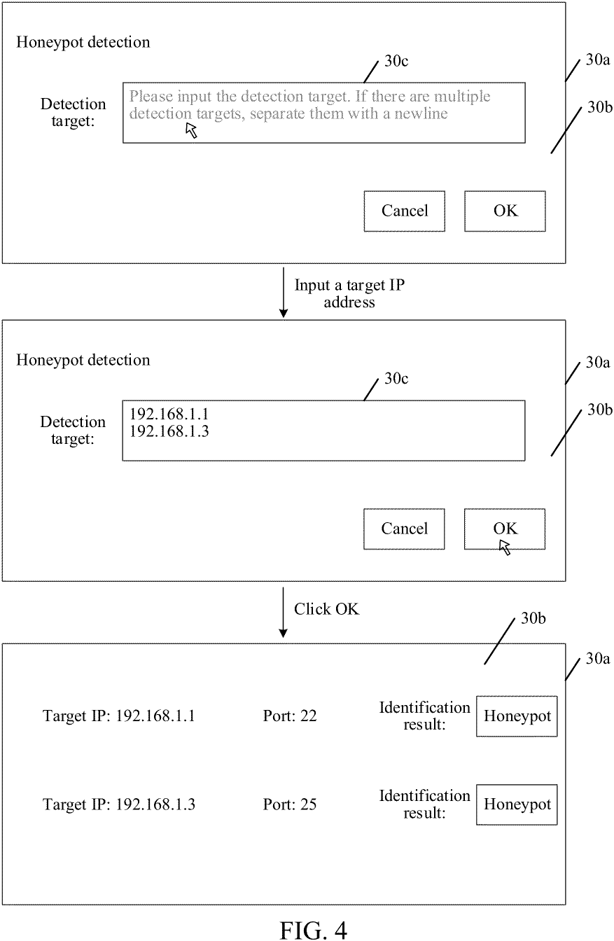

Referring to FIG. 5, FIG. 5 is a schematic flowchart of a honeypot identification method based on cyberspace mapping in some embodiments. The honeypot identification method based on cyberspace mapping may be performed by a computer device. The computer device is a terminal device, a server, a system including a terminal device and a server, or a computer program product or a computer program (including program code). As shown in FIG. 5, the honeypot identification method based on cyberspace mapping includes the following steps:

Step S201: Acquire a target IP address inputted in a honeypot detection page.

In some embodiments, when a user enters, in an address input area of a honeypot detection page, a target IP address that is to be identified, and performs a trigger operation on an “OK” control in the honeypot detection page, the computer device responds to the trigger operation for the “OK” control, and acquires, in the address input area of the honeypot detection page, the target IP address inputted by the user.

Step S202: Analyze the target IP address in a network information organization by using an information query interface associated with the target IP address.

In some embodiments, after obtaining the target IP address, the computer device acquires the information query interface corresponding to the target IP address, where the information query interface is disclosed. The information query interface is accessed to analyze the target IP address in the network information organization to obtain address key information corresponding to the target IP address. For example, the network information organization provides a query service externally. The network information organization is China Internet Network Information Center (CNNIC) in China, and queries, by using the query service provided externally by CNNIC, the address key information corresponding to the target IP address.

Step S203: Acquire geographic area location information, holder information, and a security label that are corresponding to the target IP address from the network information organization, and determine the geographic area location information, the holder information, and the security label as address key information corresponding to the target IP address.

In some embodiments, the computer device acquires, from the network information organization by using the information query interface, the address key information corresponding to the target IP address. In some embodiments, the address key information includes the geographic area location information, the holder information, and the security label. In some embodiments, the geographic area location information includes information such as a continent, a country, a province, a city, a district/county, a longitude, a latitude, a postcode, an autonomous system (AS) number, and the like. In some embodiments, the holder information includes information such as an operator and an owner.

For example, the address key information corresponding to the target IP address is: {“Continent”: “Asia”, “Country”: “China”, “Province”: “Beijing”, “City”: “Beijing”, “District/County”: “Beijing”, “Longitude”: “01.000001”, “Latitude”: “01.000001”, “Postcode”: “000001”, “AS number”: “AS0001”, “Operator”: “CTB”, “Security label”: “BOT”, “Owner”: “GG”.}

Step S204: Perform port open detection on a port set corresponding to the target IP address, and acquire, from the port set, one or more open ports corresponding to the target IP address.

In some embodiments, the computer device acquires ports 0-65535 corresponding to the target Internet Protocol address (IP address). The ports 0-65535 form a port set corresponding to the target IP address. Port open detection is successively performed on the ports 0-65535 of the target IP address to obtain an open port list, where the open port list includes one or more open ports. When performing port open detection on any port i in the port set, the computer device transmits a connection request to the port i in the port set, where i is a non-negative integer that is less than a port quantity corresponding to the port set, for example, i is a value in a range of 0-65535. In response to receiving connection confirmation data returned by the port i, an open status of the port i is determined as an opened state. In the port set, a port in an opened state is determined as one or more open ports corresponding to the target IP address, and the one or more open ports herein form an open port list. In response to that the computer device does not receive the connection confirmation data returned by the port i, the open status of the port i is determined as a non-opened state, and subsequent processing may not need to be performed on the port in the non-opened state, thereby reducing data processing pressure of the computer device, and improving processing efficiency of honeypot identification.

A manner in which the computer device acquires the one or more open ports includes full connection scanning (transmission control protocol connect, TCP connection), half connection scanning (TCP SYN), and stateless port scanning. The full connection scanning may refer to a detection service initiated by the computer device (detection part) and attempting to perform a complete TCP connection. A complete handshake process is established between the computer device and any port i in the port set, which indicates that an open status of the port i is an opened state, and the port i is determined as an open port. If a complete handshake process cannot be established between the computer device and the port i in the port set, it indicates that the open status of the port i is a non-opened state. High-efficiency port detection can be implemented in a full connection scanning manner by using a multi-thread concurrent technology, which is easy to implement in an implementation. When a hardware central processing unit (CPU), a memory, and network bandwidth of a system host meet a quality requirement, and a quantity of ports that are to be scanned is less than a quantity threshold, open port detection is performed in the foregoing full connection scanning manner, thereby improving port scanning efficiency. When the quantity of ports that are to be scanned is greater than or equal to the quantity threshold, because a Transmission Control Protocol/Internet Protocol (TCP/IP) stack may to be used in the full connection scanning manner, a quantity of ports that remain connected at the same moment is limited.

In some embodiments, half connection scanning is specially designed by using a feature of a three-way handshake. By transmitting a detection data packet request to any port i in the port set to establish a synchronize sequence number (SYN, which may be a synchronization flag) connection, if no acknowledgement number (SYN/ACK, which may be an acknowledgment flag) packet is received but a reset (RST, which may be a reset connection) data packet is received, it is determined that the port i is not enabled, that is, an open status of the port i is a non-opened state. If an SYN/ACK acknowledgement packet is received, it is determined that the port i is open, that is, the open status of the port i is an opened state, and the SYN packet is no longer replied to complete three-way handshake, but an RST packet is transmitted to terminate the connection request. Compared with the full connection scanning manner, in the half connection scanning manner, an incomplete connection is not perceived by the target server corresponding to the target IP address, and a connection establishment record is not left, thereby ensuring hidden scanning. In a manner of terminating a connection in a timely manner, the half connection scanning manner can compensate for a problem of a limit of a connection quantity of a protocol stack in the full connection scanning manner, and therefore, a scanning speed is greatly accelerated. The half connection scanning manner is more complex than the full connection scanning manner during implementation, and a new status bit data packet may be constructed according to a connection status.

In some embodiments, the computer device scans the ports in the port set in a stateless port scanning manner, and the stateless port scanning manner is used for resolving a problem of a limited quantity of connections in a protocol stack. Stateless port scanning means that an operating system may not need to care about a status of a TCP connection. When the stateless port scanning manner is used for detecting a connection established, a TCP/IP protocol stack resource of the operating system is not occupied. Instead, an application program directly performs management and maintenance at the bottom layer, and no session packaging needs to be performed on a connection status by the operating system. During implementation, key status bits and data information are directly placed in a data packet itself by using a program. In the stateless port scanning mode, the quantity of connections that can be held at the same time is no longer limited to the operating system. The system designed by itself directly packages data from the bottom layer, and maintains and manages connections, and the limit of the quantity of connections is determined by the application program. Compared with that in the operating system, an upper limit of the quantity of connections is greatly increased, thereby greatly increasing a scanning speed. In a word, the stateless port scanning mode is independent of the protocol stack and does not require independent packet transmitting and receiving logic with handshakes. In an actual application scenario, a proper scanning manner can be selected based on a desired application.

In a process of performing port open detection on the port in the port set, data in the port open detection process is recorded, where a recorded data structure field includes a target IP address, a port, and an open status of the port, and further, one or more open ports in the opened state are acquired from the port set.

Step S205: Transmit target data to a target server according to the target IP address and the one or more open ports.

In some embodiments, the computer device transmits the target data (data for a port) to the target server according to the target Internet Protocol address (IP address) and the one or more open ports, for example, separately transmits, on a network by using the one or more open ports, the target data to the target server corresponding to the target IP address. After receiving the target data transmitted by the computer device, the target server returns, to the computer device by using an open port for receiving the target data, response data corresponding to the target data.

Step S206: Receive response data that is returned by the target server for the target data, and perform feature analysis on the response data to obtain a service type corresponding to the one or more open ports.

In some embodiments, the computer device receives the response data returned by the target server, and performs feature analysis on the response data to obtain a service type respectively corresponding to each open port. For different open ports, the computer device transmits different data, and correspondingly, the target server also returns different response data. By performing feature analysis on the response data corresponding to each open port, the service type corresponding to each open port is obtained.

Step S207: Determine the target IP address, the open port, and the service type as port fingerprint information.

In some embodiments, the computer device records port fingerprint information in a fingerprint detection analysis process, and a data structure field of port fingerprint information corresponding to each port includes a target IP address, a port, and a service type corresponding to the port. For example, if the target data transmitted to the target server is a “\ r\ n\ r\ n” character, and the returned response data is a “a001” field, the service type of the port is obtained according to the response data “a001” field, so as to obtain the port fingerprint information.

Step S208: Classify the one or more open ports according to the service type in the port fingerprint information to obtain M open port groups.

In some embodiments, the computer device classifies the one or more open ports according to the service type in the port fingerprint information to obtain the M open port groups, where open ports included in one open port group have the same service type, and M is a positive integer, for example, values of M are 1, 2, .... For example, the service type includes an account login service type and a non-account login service type. The one or more open ports are classified to obtain two open port groups (in this case, the value of M is 2). One open port group includes all open ports whose service types belong to the account login service type, and the other open port group includes all open ports whose service types belong to the non-account login service type. In some embodiments, when the service type includes a service type 1, a service type 2, a service type 3, and a service type 4, the one or more open ports are divided into four open port groups (in this case, the value of M is 4), and open ports included in the same open port group all belong to the same service type.

Step S209: Determine, in the M open port groups, an open port included in an open port group whose service type is an account login service type as a target open port.

In some embodiments, the computer device selects, from the M open port groups, an open port in an open port group corresponding to the account login service type, and determines the open port as the target open port, that is, sequentially traverses service types corresponding to one or more open ports, selects, from the one or more ports, a port that uses an account and a password for login, and uses the selected open port as the target open port. All service types corresponding to the target open port are the account login service type, where the account login service type includes but is not limited to: Secure Shell (SSH, a security protocol based on an application layer and a transport layer), mysql (relational database management system), File Transfer Protocol (FTP).

Step S210: Combine an account and a password contained in an account and password dictionary to obtain N account and password combinations; and separately log in to a service of the target open port by using the N account and password combinations, and determine an account and password combination for successful login as account login information corresponding to the target open port.

In some embodiments, the computer device acquires an account and password dictionary, where the account and password dictionary includes common accounts and common passwords; and further combines the accounts and the passwords included in the account and password dictionary to obtain N account and password combinations, where N is a positive integer, for example, values of N are 1, 2, .... There are one or more target open ports. For each target open port, the N account and password combinations are used for attempting to log in to a service of the target open port, and an account and password combination that successfully logs in to the target open port is obtained. The account and password combination is account login information corresponding to the target open port. In other words, to determine an account and a password that can successfully log in to a service of a target open port, a brute-force attack is performed on the account and the password by using the account and password dictionary. A process of the brute-force attack includes: combining accounts and passwords contained in the account and password dictionary to obtain N account and password combinations, continuously attempting to log in to the service of the target open port by using the N account and password combinations, and determining an account and password combination that can successfully log in to the target open port as account login information of the target open port.

For example, the account and password dictionary includes an account 1, an account 2, an account 3, a password 1, a password 2, and a password 3. The N account and password combinations obtained by combining the accounts and the passwords in the account and password dictionary include account 1 + password 1, account 1 + password 2, account 1 + password 3, account 2 + password 1, account 2 + password 2, account 2 + password 3, account 3 + password 1, account 3 + password 2, and account 3 + password 3.

In some embodiments, to increase a speed of brute-force attack, login attempts of the N account and password combinations are performed in a distributed or multi-thread manner. The distributed manner may refer to a function implementation in which a complex task is disassembled from a single system into multiple systems. In some embodiments, a login attempt task of the N account and password combinations is split into multiple distributed subsystems to implement. This ensures that a single system fault does not cause a global task failure, and increases a success rate of a brute-force attack result. In each distributed subsystem that performs the login attempt of the account and password combination, a large quantity of login attempt tasks are still assigned, and a successful login attempt of the account and password combination is greatly accelerated in a multi-thread parallel manner.

In the brute-force attack process of the account and password combination, data in the brute-force attack process is recorded, and a recorded data structure field includes a target IP address, a target open port, a service type corresponding to the target open port, and account login information.

Step S211: Log in to the service of the target open port according to the account and the password in the account login information, and transmit a target operation instruction to the target server according to the target IP address and the target open port, so that the target server executes the target operation instruction.

In some embodiments, after obtaining, through brute-force attack, the account login information corresponding to the target open port, the computer device logs in to the corresponding target open port by using the account and the password in the account login information, and transmits, by using the target open port, the target operation instruction to the target server corresponding to the target IP address. After receiving the target operation instruction transmitted by the computer device, the target server executes the target operation instruction, so as to obtain the instruction execution result corresponding to the target operation instruction. The target operation instruction is an instruction transmitted by the computer device to the target server by using the target open port. After executing the target operation instruction, the target server returns the instruction execution result to the computer device.

Step S212: Acquire the instruction execution result returned by the target server for the target operation instruction, and determine the target IP address, the target open port, the service type corresponding to the target open port, the account login information, the target operation instruction, and the instruction execution result as system environment information.

In some embodiments, the computer device receives the instruction execution result returned by the target server for the target operation instruction, and determines, according to the target operation instruction and the instruction execution result corresponding to the target operation instruction, the system environment information corresponding to the target open port. A data structure field of the system environment information includes the target IP address, the target open port, the service type corresponding to the target open port, the account login information, the target operation instruction, and the instruction execution result.

Step S212 is merely an optional manner of determining the system environment information. The computer device may alternatively determine the system environment information in another manner, for example, determine the system environment information based on the target IP address, the target open port, the target operation instruction, and the instruction execution result.

Step S213: Separately perform data analysis on the cyberspace mapping data by using K honeypot identification policies included in an identification policy set, to obtain analysis results respectively corresponding to the K honeypot identification policies, and determine a first honeypot identification result corresponding to the target IP address according to the K analysis results.

In some embodiments, the computer device summarizes all data obtained in step S202 to step S212 to obtain the cyberspace mapping data corresponding to the target IP address, that is, the address key information corresponding to the target IP address, the one or more open ports, the port fingerprint information, the account login information, and the system environment information are combined into the cyberspace mapping data corresponding to the target IP address. The computer device acquires the K honeypot identification policies included in the identification policy set, and separately performs data analysis on the cyberspace mapping data by using the K honeypot identification policies to obtain analysis results corresponding to the K honeypot identification policies, where the K honeypot identification policies are used for identifying different types of honeypots, and K is a positive integer, for example, values of K are 1, 2, .... In response to that an analysis result of a honeypot identification policy that exists in the K honeypot identification policies is a honeypot, the honeypot result is determined as the first honeypot identification result corresponding to the target Internet Protocol address, and the honeypot result is displayed on the honeypot detection page. In response to that analysis results respectively corresponding to the K honeypot identification policies are all undetermined results, that is, no honeypot result exists in the analysis results corresponding to the K honeypot identification policies, the undetermined result is determined as the first honeypot identification result corresponding to the target Internet Protocol address, and the undetermined result is displayed on the honeypot detection page. The K honeypot identification policies include but are not limited to: an IP protocol fingerprint identification policy, a web protocol fingerprint identification policy, a special uniform resource location (URL) determining policy, a service type and IP feature combination determining policy, a port open quantity determining policy, a service fingerprint quantity determining policy, a protocol defect determining policy, and a service environment information identification policy.

The IP protocol fingerprint identification policy may refer to transmitting a character to the target server at an IP protocol layer, and determining a honeypot type of the target IP address by using a returned field.

The web protocol fingerprint identification policy may refer to a port service that accesses the target IP address at a Hypertext Transfer Protocol (HTTP) service layer. When returned HTTP content includes information that identifies its feature, it is determined, according to the returned HTTP content, whether the service is a honeypot or a type of the honeypot.

The special URL determining policy means that, in addition to using a feature character in content of an HTTP site as a honeypot determining basis, some special URL links are used for determining whether the URL is a honeypot or a type of the honeypot.

The service type and IP feature combination determining policy means that a service of an intelligent device is used at home, and generally exists in an operator network. If an IP address of the service of the intelligent device belongs to a cloud service provider, the service may be a honeypot. Generally, services that are not possible in a cloud service provider network include an industrial control service system, a router, a switch, a hardware load balancing device, a virtualization device, and the like.

The port open quantity determining policy means that the computer device counts, in the cyberspace mapping data, a port open quantity corresponding to one or more open ports, and acquires a port quantity threshold corresponding to the port open quantity determining policy; when the port open quantity is greater than the port quantity threshold, determines that an analysis result corresponding to the port open quantity determining policy is a honeypot result; and when the port open quantity is less than or equal to the port quantity threshold, determines that the analysis result corresponding to the port open quantity determining policy is an undetermined result. In other words, on a normal server, one service or a small quantity of services run on one server. Therefore, a quantity of open ports on a normal server does not exceed the port quantity threshold. In response to that a quantity of open ports on the target IP address exceeds the port quantity threshold by counting in the cyberspace mapping data, it is determined that the honeypot identification result of the target IP address is a honeypot result. In response to that the quantity of open ports on the target IP address is less than or equal to the port quantity threshold, it is determined that the honeypot identification result of the target IP address is an undetermined result.

The service fingerprint quantity determining policy means that one port on a normal server is usually bound to one service, and when a large quantity of service fingerprint information is captured from a port, it is determined that a target server corresponding to a target IP address is a honeypot.

The protocol defect determining policy means that the computer device acquires, from the cyberspace mapping data, a service protocol corresponding to the target Internet Protocol address, and transmits, to the target server, a target command character corresponding to the service protocol; receives a protocol response feature that is returned by the target server for the target command character, and determines the protocol response feature as a protocol defect feature in response to detecting that the protocol response feature does not meet a standard response feature in a protocol standard; in response to that the protocol defect feature meets a determining condition in the protocol defect determining policy, determines that an analysis result corresponding to the protocol defect determining policy is a honeypot result; and in response to that the protocol defect feature does not meet the determining condition in the protocol defect determining policy, determines that the analysis result corresponding to the protocol defect determining policy is an undetermined result. Because a service protocol displayed externally by the honeypot is independently simulated and not implemented in a protocol standard manner, some protocol detect features exist in the simulation implementation process. These protocol defect features can be used in the honeypot. Protocols that have protocol permission detection include but are not limited to: SSH protocol, Android Debug Bridge (ADB) protocol, HTTP protocol, Simple Network Management Protocol (SNMP), Intelligent Platform Management Interface (IPMI) protocol, Post Office Protocol Version 3 (POP3), and Internet Message Access Protocol (IMAP). The SSH protocol is used for multi-user session protocol conflict feature detection, the ADB protocol is used for special instruction exception protocol feature detection, the HTTP protocol is used for exception parameter error processing protocol feature detection, the SNMP protocol is used for identity authentication logical interaction protocol defect feature detection, the IPMI protocol is used for connection reset signaling exception protocol feature detection, the POP3 protocol is used for special instruction exception protocol feature detection, and the IMAP protocol is used for special instruction exception protocol feature detection.

The service environment information identification policy may refer to determining whether a current target server is a honeypot by executing some special commands and observing execution results in port services that can be successfully logged in, for example, by viewing a system user name, memory information, and service data in a database.

In some embodiments, a target honeypot identification policy is added to the identification policy set in response to the computer device detecting the target honeypot identification policy. In response to obtaining a to-be-identified Internet Protocol address in the honeypot detection page, (K + 1) honeypot identification policies in the identification policy set are used for separately performing honeypot identification on to-be-identified cyberspace mapping data corresponding to the to-be-identified Internet Protocol address, to obtain analysis results respectively corresponding to the (K + 1) honeypot identification policies. The (K + 1) honeypot identification policies include the target honeypot identification policy. A second honeypot identification result corresponding to the to-be-identified Internet Protocol address is obtained according to the analysis results respectively corresponding to the (K + 1) honeypot identification policies. In other words, the identification policy set can add a new honeypot identification policy in real time. In response to detecting a new target honeypot identification policy, the target honeypot identification policy is added to the identification policy set. The identification policy set includes (K + 1) honeypot identification policies. Subsequently, when the to-be-identified IP address is obtained, the to-be-identified cyberspace mapping data of the to-be-identified IP address is sequentially analyzed by using the (K+1) honeypot identification policies, so as to determine the second honeypot identification result of the to-be-identified IP address. The honeypot identification process of the to-be-identified IP address is the same as the honeypot identification process of the target IP address, but a new target honeypot identification policy is added. In some embodiments, the identification policy set can be updated in real time, so as to ensure that honeypot identification policies included in the identification policy set are more comprehensive, thereby improving honeypot identification accuracy of an IP address.

Step S214: Write the cyberspace mapping data and the first honeypot identification result into a first database in response to the first database serving as a primary database that provides a read/write service, and synchronously back up data stored in the first database to a second database.

In some embodiments, all configuration information and data in the target server corresponding to the target IP address are stored in one primary database and one secondary database, which can ensure that data is not lost. For example, two databases are used for storing all data in the honeypot identification process, such as the target IP address, the address key information, the one or more open ports, the port fingerprint information corresponding to the one or more open ports, the account login information, the system environment information, and the honeypot identification result. One database serves as a primary database that provides a read/write service, and the other database serves as a secondary database that backs up data. When the first database serves as the primary database, the cyberspace mapping data corresponding to the target IP address and the first honeypot identification result are written into the first database, and all data stored in the first database can be backed up synchronously to the second database.

Step S215: Disable the read/write service of the first database in response to a failure of the first database, switch the second database to the primary database that provides the read/write service, and interrupt data synchronization backup between the first database and the second database.

In some embodiments, in a process in which the first database serves as the primary database to provide the read/write service externally, if the first database is faulty, the first database cannot provide the data read/write service externally, and the data read/write service is borne by the second database. Data synchronization backup between the first database and the second database is interrupted. In other words, when the first database is faulty, the first database stops the original read/write service, and the original read/write service of the first database is borne by the second database. The data backup service is stopped when the second database bears the data read/write service.

Step S216: Synchronously back up data stored in the second database to the restored first database in response to the first database being repaired to normal.

In some embodiments, in response to that the fault in the first database is repaired, the first database is used as a backup database for backing up data, the second database is used as a primary database for providing a read/write service, and data stored in the second database is backed up synchronously to the first database after being repaired to normal.

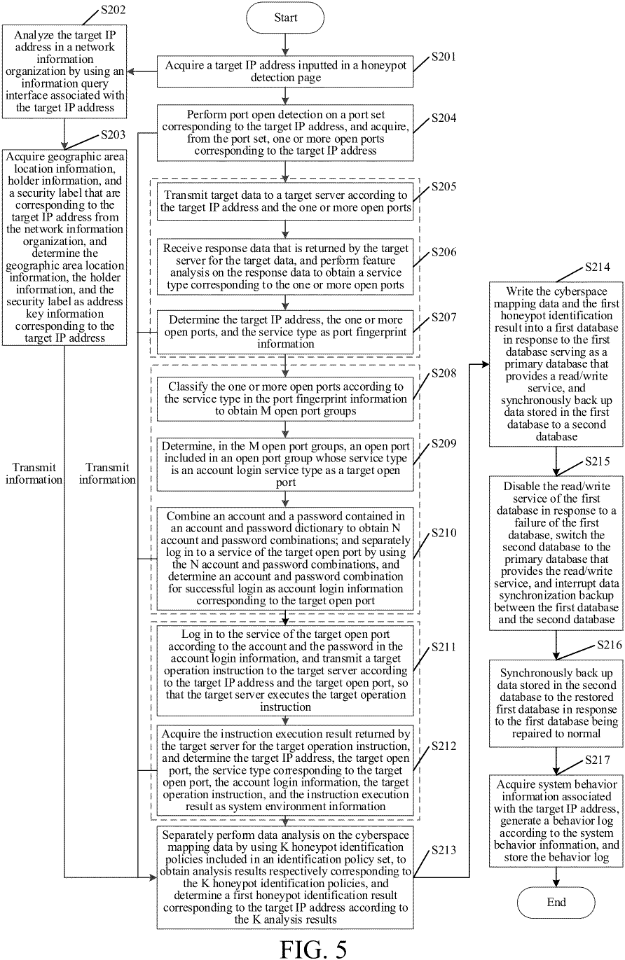

Referring to FIG. 6, FIG. 6 is a schematic diagram of data storage 600. As shown in FIG. 6, during normal working at 602, a database A (that is, the first database) is a primary database that provides a read/write service, a database B (that is, the second database) is a secondary library that performs data backup, that is, the database A can carry all data read/write work as the primary database, the database B can perform data synchronization from the database A, and back up data stored in the database A to the database B. When the database A is faulty as the primary database, at 604, the database A cannot provide the data read/write service externally. The data read/write service is borne by the database B, and the data synchronization backup between the database A and the database B is interrupted. When the fault of the database A is repaired, the identities of the database A and the database B are exchanged, at 606, the database B is switched to a primary database that provides a read/write service, the database A is switched to a secondary library that performs data backup, and the database A can perform data synchronization from the database B.

Step S217: Acquire system behavior information associated with the target IP address, generate a behavior log according to the system behavior information, and store the behavior log.

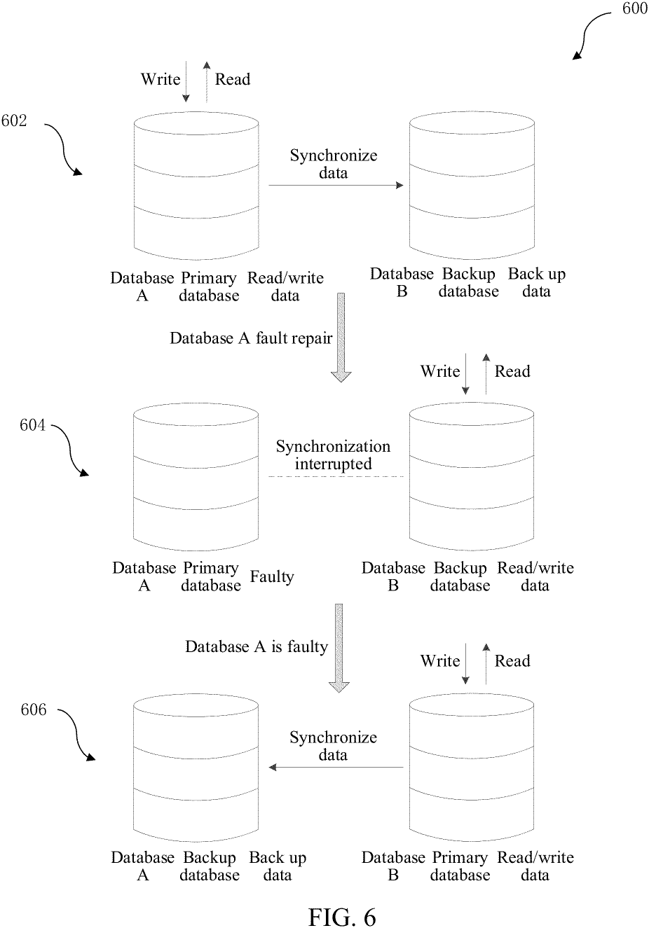

In some embodiments, the computer device records the behavior log of the target IP address in the entire honeypot identification process, so as to ensure that system running information can be traced. The behavior log is stored in a log server, and the behavior log is stored locally in a text manner. Referring to FIG. 7, FIG. 7 is a schematic diagram of behavior log storage 700. As shown in FIG. 7, after obtaining the behavior log corresponding to the target IP address, the computer device stores the behavior log 702 into the log server 704, and stores a copy locally in a text manner.

The behavior log can be classified by levels, for example, a log level includes: ERROR (error), WARN (warning), INFO (key information), and DEBUG (debugging). Log level details are shown in Table 1:

TABLE 1

| | |
|---|---|
| Level | Description |
| ERROR | The ERROR log is the highest-level error record, indicating that a very serious fault occurs in the system, which directly causes the fault to work normally. The administrator may examine the ERROR log to ensure the normal running of the service system. |
| WARN | The WARN log is a low-level exception log, indicating that the system triggers an exception process during running, but does not affect the normal operation of the system. The next service process can be executed normally. The WARN log may be examined by the administrator. Generally, it indicates that the system runs at a certain risk, and the system may be faulty. |
| INFO | The INFO log usually records the key information of the system and keeps the key operation data during the normal operation of the system. The administrator may pay attention to it during the daily operation and maintenance. |
| DEBUG | The DEBUG log is mainly used for recording the detailed system information. It is used for debugging the system, including parameter details, debugging details and running return information. |

In some embodiments, the behavior log is used for daily troubleshooting and status recording of the system, and the behavior log is classified according to log content. As shown in the following Table 2, behavior logs are divided into a configuration log, a monitoring log, an alarm log, a running log, and the like. Table 2 indicates the following:

TABLE 2

| | |
|---|---|
| Classification | Description |
| Configuration log | Records the behavior of adding, deleting and modifying configurations. |
| Monitoring log | Records the operation behavior each time the monitoring module detects the validity of the certificate of the target site. |
| Alarm log | Records the behavior of each external alarm action of the alarm module. |
| Running log | Used for recording the behavior during the entire system background running. |

In some embodiments, the log server is a blockchain system, and the computer device obtains system behavior information associated with the target Internet Protocol address (target IP address), and generates a behavior log according to the system behavior information; further, uploads the behavior log to the blockchain system, so that a blockchain node in the blockchain system encapsulates the behavior log into a transaction block, and performs accounting processing on a transaction block for which consensus is reached; receives on-chain success information returned by the blockchain node in the blockchain system, and stores a file hash of the behavior log in the blockchain system in a local database according to the on-chain success information, the file hash being used for indicating a storage location of the behavior log in the blockchain system. In other words, the computer device uploads the behavior log as transaction data to the blockchain system. After receiving the behavior log, the blockchain node in the blockchain system encapsulates the behavior log into a transaction block, and transmits the transaction block to a consensus node in the blockchain system. The consensus node performs consensus processing on the transaction block. When consensus for the transaction block is reached in the blockchain system, the transaction block for which consensus is reached is accounted. After the transaction block is successfully chained in the blockchain system, the transaction block returns the on-chain success information to the computer device for the behavior log. The on-chain success information is used for indicating that the behavior log is successfully chained in the blockchain system. The on-chain success information includes the file hash corresponding to the behavior log. After receiving the on-chain success information, the computer device locally stores the file hash. When the behavior log is queried subsequently, the behavior log is obtained from the blockchain system according to the file hash.

A blockchain is an application of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network transactions, the information being used for verifying the validity of information of the data block (anti-counterfeiting) and generating a next data block. The blockchain includes a blockchain underlying platform, a platform product service layer, and an application service layer.

The blockchain underlying platform includes processing modules such as a user management module, a basic service module, a smart contract module, and an operation supervision module. The user management module is responsible for identity information management of all blockchain participants, including maintaining public-private key generation (account management), key management, maintaining a correspondence between the real identity of a user and a blockchain address (permission management), and the like, supervising and auditing transaction conditions of some real identities with authorization, and providing rule configuration of risk control (risk control auditing). The basic service module is deployed on all blockchain node devices and configured to verify the validity of a service request, and after a consensus is reached on a valid request, record the valid request in storage. For a new service request, the basic service module first parses interface adaptation and performs authentication processing (interface adaptation), then encrypts service information by using a consensus algorithm (consensus management), transmits the complete and consistent service information after encryption to a shared ledger (network communication), and performs recording and storing. The smart contract module is responsible for contract registration and publication, contract triggering, and contract execution. A developer defines contract logic by using a programming language, and releases the contract logic onto a blockchain (contract registration). According to the logic of contract items, a key or another event is invoked to trigger execution, to complete the contract logic. The function of upgrading or canceling a contract is further provided. The operation supervision module is mainly responsible for deployment, configuration modification, contract setting, and cloud adaptation during product releasing and visualized output of a real-time status during product operation, for example, alarming, monitoring network conditions, and monitoring a health status of a node device.

The term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

The platform product service layer provides basic capabilities and an implementation framework of a typical application. Based on these basic capabilities, developers superpose characteristics of services and complete blockchain implementation of service logic. The application service layer provides a blockchain solution-based application service for use by a service participant.

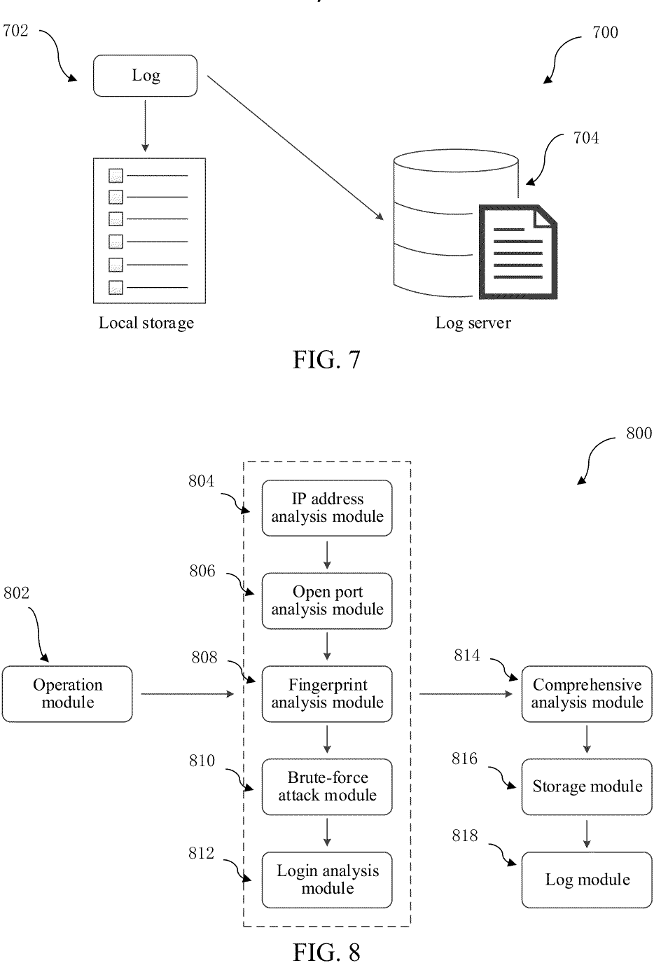

Referring to FIG. 8 together, FIG. 8 is an architectural diagram of a honeypot identification technology 800. As shown in FIG. 8, the architectural diagram of the honeypot identification technology 800 includes an operation module 802, an IP address analysis module 804, an open port analysis module 806, a fingerprint analysis module 808, a brute-force attack module 810, a login analysis module 812, a comprehensive analysis module 814, a storage module 816, and a log module 818.

The operation module 802 is an entry part of the entire architectural diagram of the honeypot identification technology. A user inputs a target IP address in the operation module 802 as a target IP address for packet detection in a honeypot identification process. The operation module 802 provides the user with a honeypot detection page for inputting the target IP address. The user enters the target IP address to be identified in the honeypot detection page provided by the operation module 802. After clicking an “OK” control in the honeypot detection page, the operation module 802 acquires the target IP address inputted by the user, and transmits the target IP address to the IP address analysis module 804.

The IP address analysis module 804 analyzes the target IP address transmitted by the operation module 802, so as to obtain address key information corresponding to the target IP address, where the address key information includes information such as a continent, a country, a province, a city, a district/county, a longitude, a latitude, a postcode, an AS number, an operator, a security label, and an owner. The address key information is queried by using a disclosed interface (for example, a China Internet Network Information Center (CNNIC) in China provides a query service). The IP address analysis module 804 transmits the address key information of the target IP address to the comprehensive analysis module 814 for comprehensive analysis. In addition, the IP address analysis module 804 transmits the address key information to the open port analysis module 806.

The open port analysis module 806 sequentially performs open port detection on ports 0-65535 of the target IP address to obtain an open port list corresponding to the target IP address, where the open port list includes one or more open ports. Further, the target IP address, the one or more open ports, and an open status corresponding to each open port are transmitted to the comprehensive analysis module 814 for comprehensive analysis. In addition, the target IP address, the one or more open ports, and the open status corresponding to each open port are transferred to the fingerprint analysis module 808. The open port analysis module 806 obtains an open status of a port on the target IP, there are a total of 65535 ports available, and the open port analysis module 806 finds the open ports.

The fingerprint analysis module 808 performs fingerprint detection analysis on the target IP address and the one or more ports that are transmitted by the open port analysis module 806, and acquires port fingerprint information corresponding to the one or more ports. The fingerprint analysis module 808 transmits data to the target IP address and the one or more ports from the network, so as to receive response data returned by the target server, and then performs feature analysis according to the returned response data to obtain a service type corresponding to the one or more ports. After completing fingerprint detection analysis, the fingerprint analysis module 808 transmits the port fingerprint information to the comprehensive analysis module 814 for comprehensive analysis. In addition, the port fingerprint information data is further transmitted to the brute-force attack module 810, where a data structure field of the port fingerprint information includes an IP, an open port, and a corresponding service type.

The brute-force attack module 810 uses an account and password dictionary to attempt to log in to the service of the target port and obtain an account and a password for successful login (that is, account login information). The brute-force attack module 810 transmits brute-force attack information including the account login information to the comprehensive analysis module 814 for comprehensive analysis. In addition, the brute-force attack information data is further transmitted to the login analysis module 812, where the brute-force attack information data includes account login information acquired for a target open port of an account login service type, and a data structure field of the brute-force attack information data includes the target IP address, the target open port, the service type corresponding to the target open port, and the account login information.

The login analysis module 812 logs in to the service of the target open port by using the account login information, acquires system environment information from the target server, and then transmits the system environment information to the comprehensive analysis module 814 for comprehensive analysis. A data structure field of the system environment information includes the target IP address, the target open port, the service type corresponding to the target open port, the account login information, a target operation instruction, and an instruction execution result.

The comprehensive analysis module 814 summarizes all data involved in the honeypot identification technology architecture, determines the summarized data as cyberspace mapping data, and obtains a honeypot identification result of the target IP address by comprehensively analyzing the cyberspace mapping data. For a comprehensive analysis process of the cyberspace mapping data, the foregoing description in step S207 may be used.

The storage module 816 stores all working data in the entire honeypot identification process. For an implementation process, the foregoing description in step S208 may be used.

The log module 818 is configured to record all behavior logs in the entire honeypot identification process. For an implementation process, the description in step S209 may be used.

In some embodiments, when honeypot identification is performed on a target IP address, the target IP address is analyzed by using cyberspace mapping, and cyberspace mapping data is summarized for comprehensive analysis, so as to determine a honeypot identification result of the target IP address, thereby improving honeypot identification accuracy. In addition, a user inputs the target IP address in a honeypot detection page, so as to obtain the honeypot identification result of the target IP address, platformize the honeypot identification work, and automatically implement the honeypot identification work. By delivering a detection instruction with one click, the user can quickly obtain the honeypot identification result of the target IP address, thereby reducing a cumbersome operation of the user, and improving honeypot identification efficiency for the target IP address. The entire honeypot identification process is monitored, and the honeypot identification process is standardized and processized, ensuring consistency of the target IP address in the honeypot identification process, and the detection details of the honeypot identification process are traced by using a behavior log, eliminating false positives. An identification policy set includes multiple honeypot identification policies that are used for detecting different honeypot types, extending the honeypot identification policies, so that honeypot identification accuracy can be further improved.

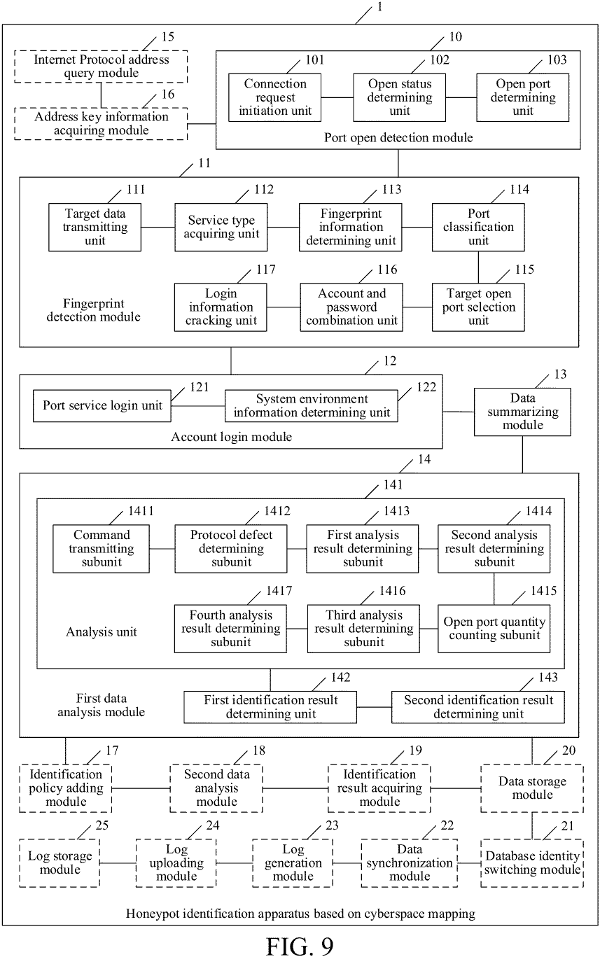

Referring to FIG. 9, FIG. 9 is a schematic structural diagram of a honeypot identification apparatus based on cyberspace mapping in some embodiments. The honeypot identification apparatus based on cyberspace mapping is configured to perform corresponding steps in the method provided some embodiments. As shown in FIG. 9, the honeypot identification apparatus 1 based on cyberspace mapping includes a port open detection module 10, a fingerprint detection module 11, an account login module 12, a data summarizing module 13, and a first data analysis module 14.

The port open detection module 10 is configured to determine one or more open ports corresponding to a target Internet Protocol address;
the fingerprint detection module 11 is configured to: determine a target open port from the one or more open ports, and acquire account login information corresponding to the target open port, a service type corresponding to the target open port being an account login service type;
the account login module 12 is configured to log in to a service of the target open port according to the account login information, and determine system environment information corresponding to the target open port;
the data summarizing module 13 is configured to determine cyberspace mapping data corresponding to the target Internet Protocol address based on the one or more open ports, the account login information, and the system environment information; and
the first data analysis module 14 is configured to perform data analysis on the cyberspace mapping data to determine a first honeypot identification result corresponding to the target Internet Protocol address.

For function implementations of the port open detection module 10, the fingerprint detection module 11, the account login module 12, the data summarizing module 13, and the first data analysis module 14, step S101 to step S106 in the embodiment corresponding to FIG. 3 may be used.

In some feasible implementations, the port open detection module 10 is configured to perform port open detection on a port set corresponding to the target Internet Protocol address, and acquire, from the port set, one or more open ports corresponding to the target Internet Protocol address.

In some feasible implementations, the port open detection module 10 includes a connection request initiation unit 101, an open status determining unit 102, and an open port determining unit 103.

The connection request initiation unit 101 is configured to transmit a connection request to a port i in the port set corresponding to the target Internet Protocol address, i being a non-negative integer that is less than a port quantity corresponding to the port set;
the open status determining unit 102 is configured to determine an open status of the port i as an opened state in response to receiving connection confirmation data returned by the port i; and
the open port determining unit 103 is configured to determine a port whose open status is the opened state in the port set as the open port.

For function implementations of the connection request initiation unit 101, the open status determining unit 102, and the open port determining unit 103, step S201 and step S204 in the embodiment corresponding to FIG. 5 may be used.

In some feasible implementations, the fingerprint detection module 11 is configured to: perform fingerprint detection analysis on the target Internet Protocol address and the one or more open ports, acquire port fingerprint information corresponding to the one or more open ports, and determine, according to a service type in the port fingerprint information, an open port whose service type is the account login service type as the target open port.

In some feasible implementations, the fingerprint detection module 11 includes a target data transmitting unit 111, a service type acquiring unit 112, and a fingerprint information determining unit 113.

The target data transmitting unit 111 is configured to transmit target data to a target server according to the target Internet Protocol address and the one or more open ports;
the service type acquiring unit 112 is configured to receive response data that is returned by the target server for the target data, and perform feature analysis on the response data to obtain a service type corresponding to the one or more open ports; and
the fingerprint information determining unit 113 is configured to determine the target Internet Protocol address, the open port, and the service type corresponding to the open port as the port fingerprint information corresponding to the open port.

In some feasible implementations, the fingerprint detection module 11 includes a port classification unit 114 and a target open port selection unit 115.

The port classification unit 114 is configured to classify the one or more open ports according to the service type in the port fingerprint information, to obtain M open port groups, open ports included in one open port group having a same service type, and M being a positive integer; and

the target open port selection unit 115 is configured to determine, in the M open port groups, an open port included in an open port group whose service type is the account login service type as the target open port.

In some feasible implementations, the fingerprint detection module 11 includes an account and password combination unit 116 and a login information cracking unit 117.

The account and password combination unit 116 is configured to combine an account and a password contained in an account and password dictionary to obtain N account and password combinations, N being a positive integer; and

the login information cracking unit 117 is configured to: separately log in to the service of the target open port by using the N account and password combinations, and determine an account and password combination for successful login as the account login information corresponding to the target open port.

For function implementations of the target data transmitting unit 111, the service type acquiring unit 112, the fingerprint information determining unit 113, the port classification unit 114, the target open port selection unit 115, the account and password combination unit 116, and the login information cracking unit 117, step S205 to step S210 in the embodiment corresponding to FIG. 5 may be used.

In some feasible implementations, the account login module 12 is configured to:
log in to the service of the target open port according to the account login information; and
acquire, by using the logged-in target open port, an instruction execution result indicated by a target operation instruction, and determine the system environment information corresponding to the target open port according to the instruction execution result.

In some feasible implementations, the account login module 12 includes a port service login unit 121 and a system environment information determining unit 122.

The port service login unit 121 is configured to: log in to the service of the target open port according to the account and the password in the account login information, and transmit a target operation instruction to the target server according to the target Internet Protocol address and the target open port, the target server being used for executing the target operation instruction.

The system environment information determining unit 122 is configured to: acquire an instruction execution result returned by the target server for the target operation instruction, and determine the system environment information based on the target Internet Protocol address, the target open port, the target operation instruction, and the instruction execution result.

For function implementations of the port service login unit 121 and the system environment information determining unit 122, step S211 and step S212 in the embodiment corresponding to FIG. 5 may be used.

In some feasible implementations, the data summarizing module 13 is configured to combine address key information corresponding to the target Internet Protocol address, the one or more open ports, port fingerprint information corresponding to the one or more open ports, the account login information, and the system environment information into cyberspace mapping data corresponding to the target Internet Protocol address.

In some feasible implementations, the honeypot identification apparatus 1 based on cyberspace mapping further includes an Internet Protocol address query module 15 and an address key information acquiring module 16.

The Internet Protocol address query module 15 is configured to analyze the target Internet Protocol address by using an information query interface associated with the target Internet Protocol address; and

the address key information acquiring module 16 is configured to acquire geographic area location information, holder information, and a security label that are corresponding to the target Internet Protocol address, and determine the geographic area location information, the holder information, and the security label as the address key information corresponding to the target Internet Protocol address.

For functional implementations of the Internet Protocol address query module 15 and the address key information acquiring module 16, step S202 and step S203 in the foregoing embodiment corresponding to FIG. 5 may be used.

In some feasible implementations, the first data analysis module 14 includes an analysis unit 141.

The analysis unit 141 is configured to separately perform data analysis on the cyberspace mapping data by using K honeypot identification policies included in an identification policy set, to obtain analysis results respectively corresponding to the K honeypot identification policies, and determine a first honeypot identification result corresponding to the target Internet Protocol address according to the K analysis results, the K honeypot identification policies being used for identifying different types of honeypots, and K being a positive integer.

In some feasible implementations, the first data analysis module 14 further includes a first identification result determining unit 142 and a second identification result determining unit 143.

The first identification result determining unit 142 is configured to: determine, in response to that an analysis result corresponding to a honeypot identification policy that exists in the K honeypot identification policies is a honeypot result, the honeypot result as the first honeypot identification result corresponding to the target Internet Protocol address; and

the second identification result determining unit 143 is configured to: determine, in response to that analysis results corresponding to the K honeypot identification policies are all undetermined results, the undetermined result as the first honeypot identification result corresponding to the target Internet Protocol address.

For function implementations of the analysis unit 141, the first identification result determining unit 142, and the second identification result determining unit 143, step S213 in the embodiment corresponding to FIG. 5 may be used.

In some feasible implementations, the K honeypot identification policies include a protocol defect determining policy.

The analysis unit 141 includes a command transmitting subunit 1411, a protocol defect determining subunit 1412, a first analysis result determining subunit 1413, and a second analysis result determining subunit 1414.

The command transmitting subunit 1411 is configured to: acquire a service protocol corresponding to the target Internet Protocol address from the cyberspace mapping data, and transmit a target command character corresponding to the service protocol to the target server;
the protocol defect determining subunit 1412 is configured to: receive a protocol response feature returned by the target server for the target command character, and determine the protocol response feature as a protocol defect feature in response to detecting that the protocol response feature does not meet a standard response feature in a protocol standard;
the first analysis result determining subunit 1413 is configured to: determine that an analysis result corresponding to the protocol defect determining policy is a honeypot result in response to that the protocol defect feature meets a determining condition in the protocol defect determining policy; and
the second analysis result determining subunit 1414 is configured to: determine that the analysis result corresponding to the protocol defect determining policy is an undetermined result in response to that the protocol defect feature does not meet the determining condition in the protocol defect determining policy.

In some embodiments, the K honeypot identification policies include a port open quantity determining policy;
the analysis unit 141 includes an open port quantity counting subunit 1415, a third analysis result determining subunit 1416, and a fourth analysis result determining subunit 1417;
the open port quantity counting subunit 1415 is configured to count, in the cyberspace mapping data, a port open quantity corresponding to the one or more open ports, and acquire a port quantity threshold corresponding to the port open quantity determining policy;
the third analysis result determining subunit 1416, configured to determine that an analysis result corresponding to the port open quantity determining policy is a honeypot result in response to that the port open quantity is greater than the port quantity threshold; and
the fourth analysis result determining subunit 1417 is configured to: determine that the analysis result corresponding to the port open quantity determining policy is an undetermined result in response to that the port open quantity is less than or equal to the port quantity threshold.

For function implementations of the command transmitting subunit 1411, the protocol defect determining subunit 1412, the first analysis result determining subunit 1413, the second analysis result determining subunit 1414, the open port quantity counting subunit 1415, the third analysis result determining subunit 1416, and the fourth analysis result determining subunit 1417, step S213 in the foregoing embodiment corresponding to FIG. 5 may be used.

In some feasible implementations, the honeypot identification apparatus 1 based on cyberspace mapping further includes an identification policy adding module 17, a second data analysis module 18, and an identification result acquiring module 19.

The identification policy adding module 17 is configured to: add, in response to detecting a target honeypot identification policy, the target honeypot identification policy to the identification policy set;
the second data analysis module 18 is configured to: separately perform, in response to obtaining a to-be-identified Internet Protocol address, data analysis on to-be-identified cyberspace mapping data corresponding to the to-be-identified Internet Protocol address by using (K+1) honeypot identification policies in the identification policy set, to obtain analysis results respectively corresponding to the (K+1) honeypot identification policies, the (K+1) honeypot identification policy including the target honeypot identification policy; and
the identification result acquiring module 19 is configured to obtain a second honeypot identification result corresponding to the to-be-identified Internet Protocol address according to the analysis results respectively corresponding to the (K+1) honeypot identification policies.

For function implementations of the identification policy adding module 17, the analysis module 18, and the identification result acquiring module 19, step S213 in the embodiment corresponding to FIG. 5 may be used.

In some feasible implementations, the honeypot identification apparatus 1 based on cyberspace mapping further includes a data storage module 20, a database identity switching module 21, and a data synchronization module 22.

The data storage module 20 is configured to: write the cyberspace mapping data and the first honeypot identification result into a first database in response to the first database serving as a primary database that provides a read/write service, and synchronously back up data stored in the first database to a second database;

The database identity switching module 21 is configured to: disable the read/write service of the first database in response to a failure of the first database, switch the second database to the primary database that provides the read/write service, and interrupt data synchronization backup between the first database and the second database; and

the data synchronization module 22 is configured to: synchronously back up data stored in the second database to the restored first database in response to the first database being repaired to normal.

For function implementations of the data storage module 20, the database identity switching module 21, and the data synchronization module 22, step S214 to step S216 in the embodiment corresponding to FIG. 5 may be used.

In some feasible implementations, the honeypot identification apparatus 1 based on cyberspace mapping further includes a log generation module 23, a log uploading module 24, and a log storage module 25.

The log generation module 23 is configured to: acquire system behavior information associated with the target Internet Protocol address, and generate a behavior log according to the system behavior information;
the log uploading module 24 is configured to upload the behavior log to a blockchain system, a blockchain node in the blockchain system being used for encapsulating the behavior log into a transaction block, and perform accounting processing on a transaction block for which consensus is reached; and
the log storage module 25 is configured to: receive on-chain success information returned by the blockchain node in the blockchain system, and store a file hash of the behavior log in the blockchain system in a local database according to the on-chain success information, the file hash being used for indicating a storage location of the behavior log in the blockchain system.

For function implementations of the log generation module 23, the log uploading module 24, and the log storage module 25, step S217 in the embodiment corresponding to FIG. 5 may be used.

In some feasible implementations, the port open detection module 10 is further configured to acquire the target Internet Protocol address from a honeypot detection page.

In some embodiments, when honeypot identification is performed on a target IP address, the target IP address is analyzed by using cyberspace mapping, and data in the cyberspace mapping process (that is, the foregoing cyberspace mapping data) is summarized for comprehensive analysis, so as to determine a honeypot identification result of the target IP address, thereby improving honeypot identification accuracy. In addition, a user inputs the target IP address in a honeypot detection page, so as to obtain the honeypot identification result of the target IP address, platformize the honeypot identification work, and automatically implement the honeypot identification work. By delivering a detection instruction with one click, the user can quickly obtain the honeypot identification result of the target IP address, thereby reducing a cumbersome operation of the user, and improving honeypot identification efficiency for the target IP address. The entire honeypot identification process is monitored, and the honeypot identification process is standardized and processized, ensuring consistency of the target IP address in the honeypot identification process, and the detection details of the honeypot identification process are traced by using a behavior log, eliminating false positives. An identification policy set includes multiple honeypot identification policies that are used for detecting different honeypot types, extending the honeypot identification policies, so that honeypot identification accuracy can be further improved.

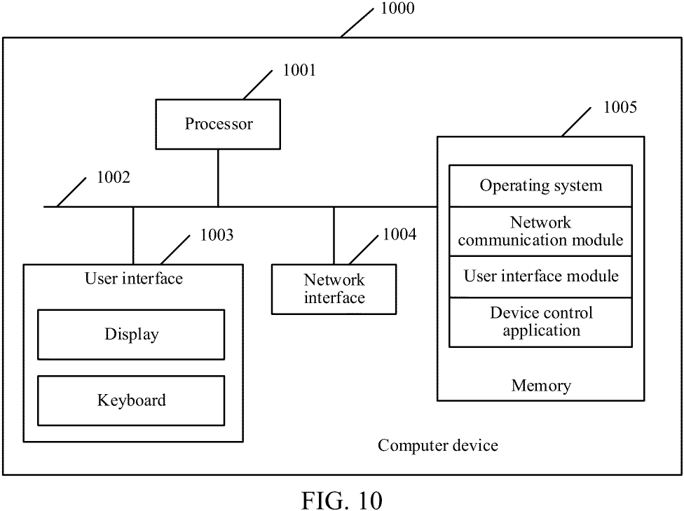

Referring to FIG. 10, FIG. 10 is a schematic structural diagram of a computer device in some embodiments. As shown in FIG. 10, a computer device 1000 includes a processor 1001, a network interface 1004, and a memory 1005. In addition, the computer device 1000 further includes a user interface 1003 and at least one communication bus 1002. The communication bus 1002 is configured to implement connection and communication between the components. The user interface 1003 includes a display and a keyboard. In some embodiments, the user interface 1003 further includes a standard wired interface and wireless interface. In some embodiments, the network interface 1004 includes a standard wired interface and a standard wireless interface (such as a Wi-Fi interface). The memory 1005 is a high-speed RAM memory, or is a non-volatile memory, for example, at least one magnetic disk memory. In some embodiments, the memory 1005 is also at least one storage device located away from the processor 1001. As shown in FIG. 10, the memory 1005 used as a non-transitory computer readable storage medium includes an operating system, a network communication module, a user interface module, and a device-control application program.

In the computer device 1000 shown in FIG. 10, the network interface 1004 may provide a network communication function. The user interface 1003 is mainly configured to provide an input interface for a user. The processor 1001 is configured to invoke the device-control application program stored in the memory 1005, to implement the following operations:
determining one or more open ports corresponding to a target Internet Protocol address;
determining a target open port from the one or more open ports, and acquiring account login information corresponding to the target open port, a service type corresponding to the target open port being an account login service type;
logging in to a service of the target open port according to the account login information, and determining system environment information corresponding to the target open port;
determining cyberspace mapping data corresponding to the target Internet Protocol address based on the one or more open ports, the account login information, and the system environment information; and
performing data analysis on the cyberspace mapping data to determine a first honeypot identification result corresponding to the target Internet Protocol address.

The computer device 1000 described in some embodiments may perform the foregoing description of the honeypot identification method based on cyberspace mapping in any one of the embodiments corresponding to FIG. 3 and FIG. 5, or may perform the foregoing description of the honeypot identification apparatus 1 based on cyberspace mapping in the embodiment corresponding to FIG. 9.

In addition, some embodiments further provide a non-transitory computer readable storage medium, and the non-transitory computer readable storage medium stores a computer program executed by the foregoing honeypot identification apparatus 1 based on cyberspace mapping, and the computer program includes program instructions. When the processor executes the program instructions, descriptions of the foregoing honeypot identification method based on cyberspace mapping in any one of the embodiments corresponding to FIG. 3 and FIG. 5 can be executed. The descriptions of the method embodiments of this application may also be used for the non-transitory computer readable storage medium embodiments described. As an example, the program instructions may be deployed on one computing device, or executed on multiple computing devices located at one location, or executed on multiple computing devices distributed at multiple locations and interconnected by using a communication network, and a blockchain system is formed by multiple computing devices distributed at multiple locations and interconnected by using a communication network.

In addition, some embodiments provide a computer program product or a computer program. The computer program product or the computer program includes computer instructions, and the computer instructions are stored in a computer-readable storage medium. A processor of a computer device reads the computer instructions from the non-transitory computer readable storage medium, and the processor executes the computer instructions, so that the computer device executes the foregoing descriptions of the honeypot identification method based on cyberspace mapping in any one of the embodiments corresponding to FIG. 3 and FIG. 5. The descriptions in the method embodiments of this application may be used for the computer program embodiments as well.

With regard to the foregoing various method embodiments, for the purpose of simple description, the method embodiments are described as combinations of a series of actions, but are not limited to the described order of the actions, as some steps can be performed in different orders or some steps may be performed concurrently. In addition, the foregoing descriptions are merely examples, and are not limiting on this disclosure.

The modules may be combined, divided, or deleted in some embodiments.

All or a part of the processes of the method in the foregoing embodiment can be implemented by a computer program instructing relevant hardware. The computer program may be stored in a non-transitory computer readable storage medium. When the program is run, the processes of the methods in the foregoing embodiments are performed. The foregoing storage medium may include a magnetic disc, an optical disc, a read-only memory (ROM), a random access memory (RAM), or the like.

What is describes above are merely examples, and are not intended to limit the scope of the claims of this disclosure.

What is claimed is:

1. A honeypot identification method based on cyberspace mapping, the method comprising:
determining one or more open ports corresponding to a target Internet Protocol address;
determining a target open port from the one or more open ports;
acquiring account login information corresponding to the target open port, a service type corresponding to the target open port being an account login service type;
logging in to a service of the target open port based on the account login information, and determining system environment information corresponding to the target open port;
determining cyberspace mapping data corresponding to the target Internet Protocol address based on the one or more open ports, the account login information, and the system environment information; and
analyzing the cyberspace mapping data to determine a first honeypot identification result corresponding to the target Internet Protocol address.

2. The method according to claim 1, wherein determining one or more open ports further comprises:
performing port open detection on a port set corresponding to the target Internet Protocol address, and determining, in the port set, one or more open ports corresponding to the target Internet Protocol address.

3. The method according to claim 2, wherein performing port open detection and determining, in the port set, one or more open ports further comprises:
transmitting a connection request to a port i in the port set corresponding to the target Internet Protocol address, i being a non-negative integer that is less than a port quantity corresponding to the port set;
determining an open status of the port i as an opened state in response to receiving connection confirmation data returned by the port i; and
defining a port with the open status in the opened state to be the open port.

4. The method according to claim 1, wherein determining a target open port further comprises:
performing fingerprint detection analysis on the target Internet Protocol address and the one or more open ports;
acquiring port fingerprint information corresponding to the one or more open ports; and
defining, according to a service type in the port fingerprint information, an open port with the service type of the account login service type to be the target open port.

5. The method according to claim 4, wherein acquiring port fingerprint information further comprises:
transmitting target data to a target server based on the target Internet Protocol address and the one or more open ports;
receiving response data returned by the target server for the target data;
performing feature analysis on the response data to obtain a service type corresponding to the one or more open ports; and
defining the target Internet Protocol address, the open port, and the service type corresponding to the open port to be the port fingerprint information corresponding to the open port.

6. The method according to claim 4, wherein defining the open port further comprises:
classifying the one or more open ports based on the service type in the port fingerprint information to obtain M open port groups, wherein the open ports comprised within one open port group have a same service type, and M being a positive integer; and
determining, in the M open port groups, an open port comprised in an open port group with the service type of the account login service type as the target open port.

7. The method according to claim 1, wherein acquiring account login information further comprises:
combining an account and a password contained in an account and password dictionary to obtain N account and password combinations, N being a positive integer; and
separately logging in to the service of the target open port by using the N account and password combinations; and
determining the account and password combination with a successful login corresponding to the target open port.

8. The method according to claim 1, wherein logging in to a service of the target open port and determining system environment information further comprises:
acquiring, by using the logged-in target open port, an instruction execution result indicated by a target operation instruction, and determining the system environment information corresponding to the target open port based on the instruction execution result.

9. The method according to claim 8, wherein the acquiring the instruction execution result and determining the system environment information further comprises:
transmitting a target operation instruction to a target server based on the target Internet Protocol address and the target open port, the target server being configured to execute the target operation instruction; and
acquiring an instruction execution result returned by the target server; and
determining the system environment information based on the target Internet Protocol address, the target open port, the target operation instruction, and the instruction execution result.

10. The method according to claim 1, wherein determining the cyberspace mapping data further comprises:
combining address key information corresponding to the target Internet Protocol address, the one or more open ports, port fingerprint information corresponding to the one or more open ports, the account login information, and the system environment information into the cyberspace mapping data corresponding to the target Internet Protocol address.

11. The method according to claim 10, further comprising:
analyzing the target Internet Protocol address using an information query interface associated with the target Internet Protocol address;
acquiring geographic area location information, holder information, and a security label corresponding to the target Internet Protocol address; and
defining the geographic area location information, the holder information, and the security label to be the address key information corresponding to the target Internet Protocol address.

12. The method according to claim 1, wherein analyzing the cyberspace mapping data further comprises:
separately analyzing the cyberspace mapping data by using K honeypot identification policies comprised in an identification policy set to obtain analysis results respectively corresponding to the K honeypot identification policies; and
determining a first honeypot identification result corresponding to the target Internet Protocol address based on the obtained analysis results, the K honeypot identification policies identifying different types of honeypots, and K being a positive integer.

13. The method according to claim 12, wherein determining the first honeypot identification result further comprises:
defining, when an analysis result corresponding to a honeypot identification policy that exists in the K honeypot identification policies is a honeypot result, the honeypot result to be the first honeypot identification result corresponding to the target Internet Protocol address; and
defining, when the analysis results corresponding to the K honeypot identification policies are all undetermined results, the undetermined result to be the first honeypot identification result corresponding to the target Internet Protocol address.

14. The method according to claim 12, wherein the K honeypot identification policies comprise a protocol defect determining policy; and
wherein separately analyzing the cyberspace mapping data further comprises:
acquiring a service protocol corresponding to the target Internet Protocol address from the cyberspace mapping data and transmitting a target command character corresponding to the service protocol to the target server;
receiving a protocol response returned by the target server and defining the protocol response to be a protocol defect in response to detecting that the protocol response does not meet a standard response in a protocol standard;
determining that an analysis result corresponding to the protocol defect determining policy is a honeypot result in response to the protocol defect meeting a determining condition in the protocol defect determining policy; and
determining that the analysis result corresponding to the protocol defect determining policy is an undetermined result in response to the protocol defect does not meeting the determining condition in the protocol defect determining policy.

15. The method according to claim 12, wherein the K honeypot identification policies comprise a port open quantity determining policy; and
wherein separately analyzing the cyberspace mapping data further comprises:
counting, in the cyberspace mapping data, a port open quantity corresponding to the one or more open ports and acquiring a port quantity threshold corresponding to the port open quantity determining policy;
determining that an analysis result corresponding to the port open quantity determining policy is a honeypot result in response to the port open quantity being greater than the port quantity threshold; and
determining that the analysis result corresponding to the port open quantity determining policy is an undetermined result in response to the port open quantity being less than or equal to the port quantity threshold.

16. The method according to claim 12, further comprising:
adding, in response to detecting a target honeypot identification policy, the target honeypot identification policy to the identification policy set;
separately performing, in response to obtaining a to-be-identified Internet Protocol address, data analysis on to-be-identified cyberspace mapping data corresponding to the to-be-identified Internet Protocol address by using (K+1) honeypot identification policies in the identification policy set to obtain analysis results respectively corresponding to the (K+1) honeypot identification policies, the (K+1) honeypot identification policy comprising the target honeypot identification policy; and
obtaining a second honeypot identification result corresponding to the to-be-identified Internet Protocol address based on the analysis results respectively corresponding to the (K+1) honeypot identification policies.

17. The method according to claim 1, further comprising:
writing the cyberspace mapping data and the first honeypot identification result into a first database, the first database serving as a primary database and providing a read/write service;
synchronously backing up data stored in the first database to a second database;
disabling the read/write service of the first database in response to a failure of the first database, switching the second database to the primary database that provides the read/write service, and interrupting data synchronization backup between the first database and the second database; and
synchronously backing up data stored in the second database to the first database in response to the first database restoring functionality.

18. The method according to claim 1, further comprising:
acquiring system behavior information associated with the target Internet Protocol address and generating a behavior log based on the system behavior information;
uploading the behavior log to a blockchain system, a blockchain node in the blockchain system being used for encapsulating the behavior log into a transaction block, and performing accounting processing on a transaction block for which consensus is reached; and
receiving on-chain success information returned by the blockchain and storing a file hash of the behavior log in the blockchain system in a local database based on the on-chain success information, the file hash indicating a storage location of the behavior log.

19. An apparatus comprising:
a memory, the memory storing computer-readable instructions for honeypot identification based on cyberspace mapping; and
a processor in communication with the memory, the processor configured by the computer-readable instructions to:
determine one or more open ports corresponding to a target Internet Protocol address;
determine a target open port from the one or more open ports;
acquire account login information corresponding to the target open port, a service type corresponding to the target open port being an account login service type;
log in to a service of the target open port based on the account login information, and determine system environment information corresponding to the target open port;
determine cyberspace mapping data corresponding to the target Internet Protocol address based on the one or more open ports, the account login information, and the system environment information; and
analyze the cyberspace mapping data to determine a first honeypot identification result corresponding to the target Internet Protocol address.

20. A non-transitory computer readable storage medium, comprising processor executable instructions for performing a honeypot identification method based on cyberspace mapping, the processor executable instructions, when executed by a processor, configured to cause the processor to:
determine one or more open ports corresponding to a target Internet Protocol address;
determine a target open port from the one or more open ports;
acquire account login information corresponding to the target open port, a service type corresponding to the target open port being an account login service type;
log in to a service of the target open port based on the account login information, and determining system environment information corresponding to the target open port;
determine cyberspace mapping data corresponding to the target Internet Protocol address based on the one or more open ports, the account login information, and the system environment information; and
analyze the cyberspace mapping data to determine a first honeypot identification result corresponding to the target Internet Protocol address.
